(19) United States
(12) Patent Application Publication
(10) Pub. No.: US 2014/0180665 A1
(43) Pub. Date: Jun. 26, 2014

(54) Transparent Intellectual Network Storage Device

(71) Applicants: Andriy NAYDON, Dnepropetrovsk (UA); Sergiy Naydon, Dnepropetrovsk (UA); Anton Kolomyeytsev, Kiev (UA)

(72) Inventors: Andriy NAYDON, Dnepropetrovsk (UA); Sergiy Naydon, Dnepropetrovsk (UA); Anton Kolomyeytsev, Kiev (UA)

(21) Appl. No.: 14/194,841

(22) Filed: Mar. 3, 2014

Related U.S. Application Data
(63) Continuation-in-part of application No. 12/538,938, filed on Aug. 11, 2009, now abandoned.
Application No. 12/538,938 is a continuation-in-part of application No. 11/325,672, filed on Jan. 4, 2006, now abandoned.

(51) Int. Cl. G06F 9/455

(52) U.S. Cl. CPC G06F 9/455
USPC 703/25

(57) ABSTRACT

The invention is an intellectual network storage device that uses a network to store and retrieve data, and that connects to an existing storage controller of a host computer. The device is transparent to the operating system of the host computer, and thus does not require additional software, such as a device driver, to operate. The device includes a device board, which is connected to an existing storage controller of a host computer via any suitable interface, a set of hardware or software acting as a remote storage server, and a connection that carries signals between the device board and the remote storage server.

### CROSS-REFERENCES TO RELATED APPLICATIONS

This application is a continuation-in-part of application Ser. No. 12/538,938, filed Aug. 11, 2009 and titled “Transparent Intellectual Network Storage Device”, which is itself is a continuation-in-part of application Ser. No. 11/325,672, filed Jan. 4, 2006 and also titled “Transparent Intellectual Network Storage Device”. The disclosures of said applications and their entire file wrappers (including all prior art references cited therein) are hereby specifically and expressly incorporated by reference in their entirety as if set forth fully herein. Furthermore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates to the way a “networked” storage device is plugged into the host system. In all other prior art storage networks, a dedicated storage controller maintains a plurality of “networked” storage devices, which requires a set of device drivers (typically, a driver for each networked storage device) running on the host central processor unit (CPU) under control of the operating system (OS).

In contrast, in the invention the intellectual network storage device (iNSD) is plugged directly into the existing storage controller already present in the host system, rather than to the system bus expansion slot. Thus in the invention, no additional software is required to make the iNSD operational, except the already present storage interface controller driver.

Said another way, from the viewpoint of the host machine OS, the iNSD of the invention represents a well-known storage device type (e.g., an HDD, CDROM, etc.) attached to an already recognized storage interface controller (e.g., an onboard PCI IDE controller) which is supported by the OS. This means that as far as the host machine OS is concerned, no new, unsupported storage controller with unknown architecture and an unknown set of storage devices is being attached to the host machine, and therefore no additional device driver or other software is needed.

2. Description of the Related Art

In order to increase performance and capacity of an already installed system, new storage devices are added. However, it is not always possible to attach a new storage device directly to the host machine because of physical limitations (no more device expansion bays, power supply is limited, system case is under warranty and cannot be opened, etc.), and because of logical reasons (e.g., it is easier and cheaper to maintain a single large hard disk drive shared between multiple users than attach a small hard disk to each user's machine to get equivalent additional storage size). That's why network storage devices exist.

To overcome physical limitations or for the logical reasons discussed above, either existing or newly created network infrastructure is used to carry storage traffic, storage devices are added to one or multiple storage server nodes, and all user machines get equipped with some client software and/or hardware which is used to communicate with remote server nodes on behalf of requests arriving from the OS on client machines. Presently, two approaches are used:

1) A “fully software” solution which requires no additional hardware besides the already existing network interface card (NIC),
2) A “partially hardware” solution which involves some form of special storage controller card inserted into an expansion slot on the client computer and controlled by specialized driver software. A storage controller such as this has a direct network connection, and does not use any existing NICs.

Neither of these prior art approaches is satisfactory. A fully software solution is cheaper, but a partially hardware solution is faster and easier to use. In addition, in the case of the fully software solution, the following problems are apparent:
All newly installed operating systems must have quite a complex set of software to make the network interface card (NIC) hardware work also as storage controllers.
A fully software solution is very difficult to make bootable. Thus, at least one hard disk drive must be present in the machine to boot the operating system (OS), and only additional storage could be added as “network storage”. Even if a fully software “boot enabled” solution is used, the client software is very complex and additional server software must be installed.
The software set in a fully software solution is very central processor unit (CPU) hungry—i.e., it uses up a lot of CPU capacity. This degrades the performance of the entire system.

An example of a fully software solution is Microsoft's iSCSI initiator, which creates a set of storage devices in software (on a virtual SCSI controller) and propagates requests sent to these devices by OS to some remote server by means of Internet SCSI (iSCSI) protocol. But this solution has limited OS support, and also cannot be used as a boot device because virtual devices are not supported by BIOS.

With a partially hardware solution, most of the above-mentioned problems are solved. For example, such solutions are easier to boot as they may contain onboard BIOS, no additional local storage is required, and they always have on-board processors to handle data management thus off-loading the host CPU.

An example of a hardware solution are iSCSI adapters manufactured by some vendors (e.g., Intel, etc.) which are inserted into PCI expansion slot on host computer. Nevertheless, there still must be software support (such as the installation of a driver set) from such iSCSI controller vendor or operating system vendor, and this is a major disadvantage.

### SUMMARY OF THE INVENTION

The invention is an intellectual network storage device that uses a network to store and retrieve data, and that connects to an existing storage controller of a host computer. The device is transparent to the operating system of the host computer, and thus does not require additional software, such as a device driver, to operate. The device includes a device board, which is connected to an existing storage controller of a host computer via any suitable interface, a set of hardware or software acting as a remote storage server, and a connection that carries signals between the device board and the remote storage server.

It is therefore an object of the present invention to provide a “fully hardware” network storage solution that needs no additional operating system support except the support already built-in for the existing storage controller. The invention is thus a “transparent” intellectual network storage device (iNSD).

It is a further object of the invention to provide an iNSD that can connect to different types of existing storage controllers, and connect to them via a variety of interfaces.

It is a further object of the invention to provide an iNSD that can communicate with the existing storage controller of a computer, and with a remote storage server, via either standard/known or non-standard communication protocols.

It is a further object of the invention to provide an iNSD that is easy to make bootable, does not require an additional hard disk to boot the OS locally, and does not consume excessive amounts of host computer CPU resources or degrade overall system performance.

Further objects and advantages of the invention will become apparent from a consideration of the ensuing description and drawings.

### DESCRIPTION OF THE DRAWINGS

FIG. 1 is a diagram showing the major components of the transparent iNSD device, and how it interfaces with a host/client computer and a remote storage server.

FIG. 2 is a diagram showing how a generic network storage controller (either software/virtual or hardware) is installed in prior art solutions, and what the created virtual storage device looks like in the operating system storage device stack.

FIG. 3 is a diagram showing how the intellectual network storage device (iNSD) of the invention plugs into an existing storage controller expansion port (e.g., the primary channel of the onboard PCI IDE controller), and what the iNSD looks like in the operating system storage device stack.

FIG. 4 is a diagram showing prior art solutions wherein the storage device has its own memory and its own firmware running on an on-board microcontroller.

FIG. 5 is a diagram showing an additional embodiment of the invention, wherein the device has no on-board memory except the one used for caching, and also has no actual device implementation code/firmware.

### DETAILED DESCRIPTION OF THE INVENTION

The following provides a list of the reference characters used in the drawings:
10. Device board
11. Storage controller
12. Host computer
13. Remote storage server
14. Connection
15. Storage interface command packet
16. Response
17. Local disk
18. Server storage node
19. Network I/O
20. Remote disk
21. Primary master
22. PCI IDE controller
23. Cache Memory
24. Central Processing Unit (CPU)
25. Firmware
26. Host
27. Device
28. Simple CPU
29. Cache
30. Device network interface
31. Server network interface
32. Server
33. CPU
34. Device firmware

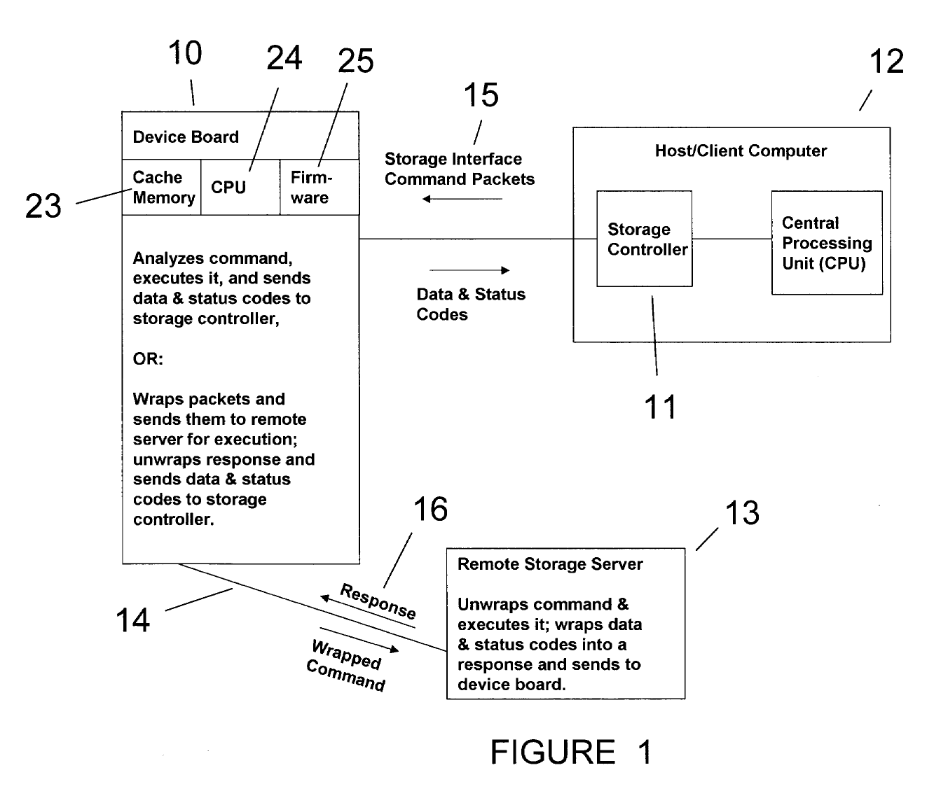

As shown in FIG. 1, the transparent intellectual network storage device of the invention includes an actual device board 10, which is plugged into either the internal or external port of the existing storage controller 11 of the host computer 12. It should be noted that it does not matter what particular storage interface is used. As just example of two possible connection means between device board 10 and storage controller 11, device board 10 can connect directly to a PCI IDE controller via a 40-pin parallel ATA cable or a serial ATA cable, depending on the PCI IDE controller type and iNSD version.

The invention also includes a set of hardware or software acting as a remote storage server 13 (which can be, for example, a “network server”, or a World Wide Web/Internet server where an HDD image file is stored and accessed by the Intellectual Network Storage Device), and a connection 14 (either a physical wired connection or a wireless connection can be used) that carries signals between device board 10 and remote storage server 13.

Device board 10 is responsible for storage interface dependent device emulation—i.e., dealing with storage interface command packets 15 sent from storage controller 11. Device board 10 has local cache memory 23, a Central Processing Unit (CPU) 24, and firmware 25 located thereon—and thus device board 10 can forward requests/commands to remote storage server 13, but it is not limited to doing that. Using its cache memory 23, CPU 24, and firmware 25, device board 10 can also analyze an incoming command and execute the command by itself in the best way according to current architecture—without sending it to a remote storage server.

When device board 10 forwards a request/command to remote storage server 13 instead of executing the command itself, device board 10 wraps the command into network interface dependent protocol, and sends it for execution to remote storage server 13. Device board 10 is also responsible for receiving responses 16 from remote storage server 13, unwrapping the data and corresponding status codes contained therein, and providing storage controller 11 with the correct data and status codes which constitute the reply to the storage interface command packet 15 request which was previously issued. It can be understood that when device board 10 analyzes an incoming command and executes the command by itself without a remote storage server, the device board will by itself provide storage controller 11 with the correct data and status codes which constitute the reply to the storage interface command packet 15 request which was issued.

Thus it can be seen that the Intellectual Network Storage Device of the invention is in fact a “real device”, which interprets commands like a normal mass storage appliance (Hard Disk Drive/HDD, CDROM, etc.). However, instead of accessing rotating media it will access a remote storage server, unless the data it requires can be found in its local cache memory 23. Said another way, the Intellectual Network Storage Device is not a mere “bridge” between devices.

By way of further explanation, a real HDD accepts commands from a host and analyzes them, then executes and returns a result to the host. The HDD may either access data from cache or access data from rotating media, such as a disk. The Intellectual Network Storage Device of the invention is the same, except that it does not have any disk. So it accesses data from a remote storage server instead of a disk, or from its own onboard cache memory 23.

Said another way, a typical storage device has an optical or magnetic head and servo mechanism to access data from local media—but in the Intellectual Network Storage Device, the optical or magnetic head and servo mechanism is replaced by some network protocol which is used to access the data. In all other aspects, the Intellectual Network Storage Device appears, to the host computer's operating system, to be a typical hard disk, CDROM, DVDROM or any other kind of available storage device which can be attached to a storage controller available on a host computer.

One non-limiting example of the way in which the Intellectual Network Storage Device works with the host computer and the remote storage server, and also uses its own onboard cache memory 23, follows:

Let's assume that the host computer operating system was just booted after power-on and tries to access the Intellectual Network Storage Device. The cache memory 23 in the Intellectual Network Storage Device is empty at this stage. The Intellectual Network Storage Device appears, to the host computer operating system, to be an HDD.
a) Let's say that the host computer operating system sends a command to the Intellectual Network Storage Device, to read the first 16 sectors of HDD (from 0 to 15).
b) The Intellectual Network Storage Device accepts this command, analyzes it and sends the data request to the remote storage server for sectors 0-15 using some network protocol.
c) The remote storage server returns the data for sectors 0-15; the Intellectual Network Storage Device returns them to the host computer and also stores the data in its local cache memory for future reference.
d) Now, the host computer sends a new command to the Intellectual Network Storage Device to read, say, sector 5 of HDD.
e) The Intellectual Network Storage Device analyzes the new command, and finds out that sector 5 is already in its cache memory. Thus it is not necessary for the Intellectual Network Storage Device to access the remote storage server. Instead, the Intellectual Network Storage Device can save time and return the data for sector 5 immediately from its cache memory.

This simple example illustrates how the cache memory inside the Intellectual Network Storage Device works. Other storage devices cache data from rotating media—while in contrast, the Intellectual Network Storage Device uses its onboard memory to cache data from a remote storage server/network server.

Connection 14 (again, either a physical wired connection or a wireless connection) is responsible for providing all required network transport between device board 10 and remote storage server 13. The particular protocol used for communications may vary, depending on the storage interface type used and other factors.

Remote storage server 13 is responsible for receiving requests from device board 10 over connection 14, unwrapping storage interface command packets 15 that are wrapped in network protocol, and executing the storage interface command either in software or in hardware.

It should be noted that communication between device board 10 and storage controller can make use of absolutely standard means. Thus, the invention does not require any modification to the storage controller for communication—for example, it can use standard ATA/ATAPI protocol via 40-pin or serial cable, or use standard communication via USB wire in the same manner as any other external USB storage, e.g., memory sticks or USB flash cards.

Communication between device board 10 and remote storage server 13 can be performed using standard network packets—e.g., via standard TCP/IP protocol or low level Ethernet frames (if the server resides on the same network segment), depending on iNSD version and configurable options. No changes are required to existing network infrastructure.

As discussed above, to carry out these tasks the invention uses the already existing storage controller 11. Device board 10 is attached directly to storage controller 11, instead of plugging into the system bus expansion slot (for example PCI) as all other prior art storage controllers do. Thus instead of representing a new storage controller that would need additional software to operate, the invention represents a different class of hardware to the operating system of host computer 12—that is, a storage device co-working with existing storage controller 11.

As a more specific example, the iNSD of the invention can be plugged directly into an onboard PCI IDE controller (configured either as master or slave), and can represent a type of hard disk drive (HDD). The PCI IDE controllers that are available today on practically any personal computer have built-in support in most operating systems, and thus no additional drivers are required to support the iNSD of the invention. Moreover, as the BIOS on most motherboards contains support for PCI IDE devices, it is even possible to boot from the iNSD of the invention without any additional hardware or software support, because the iNSD looks like a standard ATA/ATAPI device located on the IDE bus.

Such an architecture allows one to use the existing storage controller 11 and its drivers to make the iNSD of the invention accessible to the operating system. Thus the invention has all the advantages of a “partially hardware” network storage controller (easy to make bootable, no need for additional hard disk to boot OS locally, and high system performance as dedicated CPU is used), without the disadvantage of needing an additional device driver.

The iNSD of the invention can also be configured to operate correctly regardless of whether host computer 12 uses a local hard disk to boot its operating system. If host computer 12 uses a local hard disk to boot its operating system, the iNSD (specifically, device board 10) can be plugged into storage controller 11, and because the OS already has a driver for storage controller 11 installed it would automatically recognize the iNSD device.

If host computer 12 does not use a local hard disk to boot its operating system, the iNSD of the invention can be plugged into an available storage controller device expansion slot. The operating system is then installed into the iNSD, in order to boot remotely from network storage. In this case, there would be still a need for a storage device driver; however, these are much more widely supported and there would be no need to provide a driver written specifically for the iNSD of the invention.

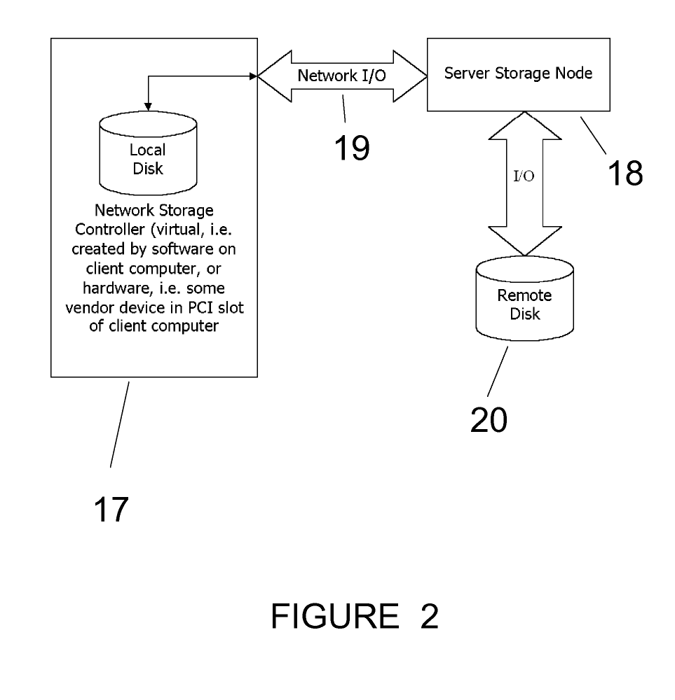

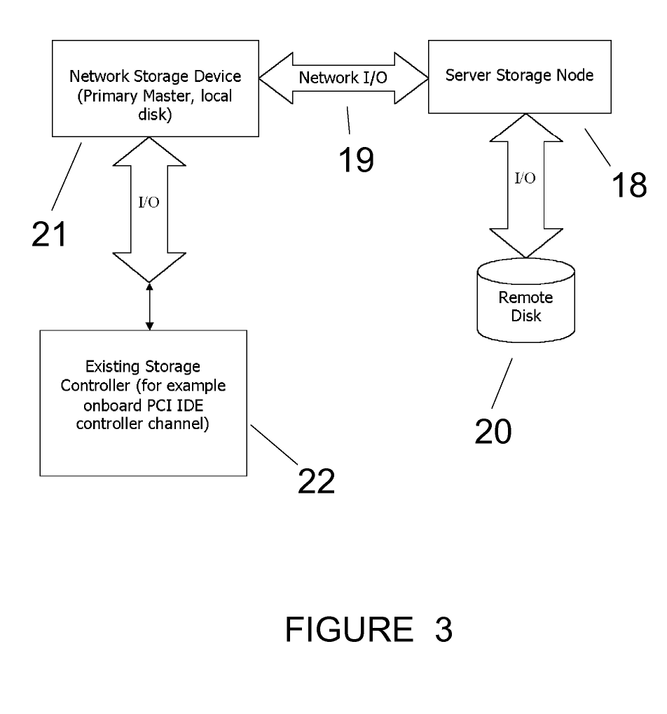

FIGS. 2 and 3 provide further perspective on the differences between prior art solutions and the iNSD of the invention:

FIG. 2 shows how a generic network storage controller (either software/virtual or hardware) is installed in prior art solutions, and what the created storage device looks like in the operating system storage device stack. Local disk 17 represents a network storage controller—either a virtual device created by software on a host computer or a hardware device plugged into, for example, the PCI slot of the host computer. Whether software or hardware-based, local disk 17 is visible to the OS of the host computer. Every request sent by the OS to local disk 17 is propagated to server storage node 18 using network I/O 19. Server storage node 18 further communicates with a remote disk 20. It can be appreciated that in order for the OS to access server storage node 18 or remote disk 20, an additional vendor driver is required to drive the network storage controller (local disk 17) because the network storage controller usually has some special hardware/software implementation that has no built-in support in most OS.

FIG. 3 is a diagram showing how the intellectual network storage device (iNSD) of the invention plugs into an existing storage controller expansion port (e.g., the primary channel of the onboard PCI IDE controller), and what the iNSD looks like in the operating system storage device stack. The intellectual network storage device (iNSD) of the invention represents a local hard disk visible to the OS of a host computer as a primary master 21 connected to a PCI IDE controller 22 onboard the host computer. Thus the iNSD requires absolutely no additional software driver support, because PCI IDE controller 22 already contains all the necessary support inside the OS and BIOS of the host computer.

It should also be understood that the remote storage server does not need to map directly all iNSD accesses to a “real device” on the remote storage server side, such as remote disk 20. As one example thereof, the server can instead map all iNSD accesses to an image file, memory block (RAM disk), etc. Said another way, server storage node 18 is simply used to access data in some way; it is not associated directly with the iNSD which is attached on the host computer/client side. The specific method used by server storage node 18 to store data is not critical to the invention and does not limit it.

The invention has a further embodiment, in which the device has no on-board memory except the one used for caching, and also has no actual device implementation code/firmware. Instead, the device firmware resides on the server.

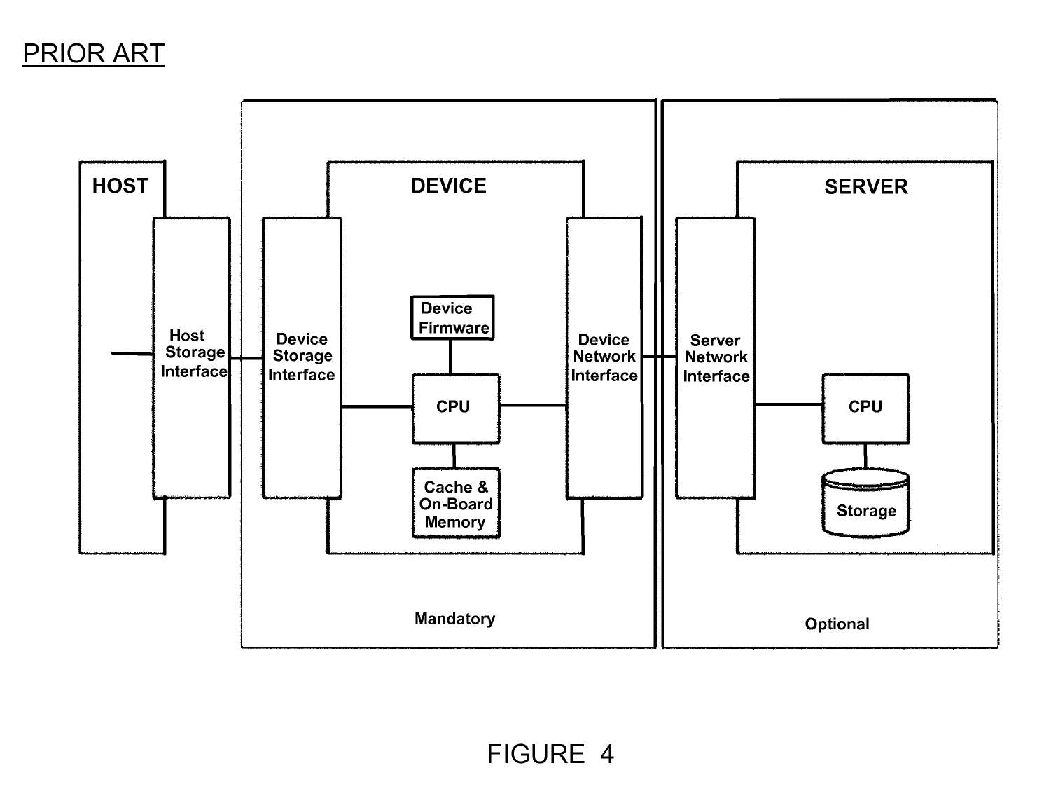

To appreciate the fundamental difference between this embodiment and the prior art, it is useful to first review currently known network storage devices and systems. FIG. 4 illustrates such a known device, and the host and server components with which the device works. These devices all have a stand-alone storage device (often a memory card) with its own memory (usually flash memory), its own actual device implementation code (that is, the device firmware runs on an on-board microcontroller), and with the optional ability to upload content to a remote server without intervention of a host.

Thus in prior art systems, the host sends I/O requests to the device. The device's CPU either delivers data from or sends data to the cache/storage component, or uses the device network interface to talk to the server once a connection to the server has been established. If there is no connection established, the device uses the cache/storage on-board memory only. Simply put, in prior art systems the device is mandatory and the server is optional.

In sharp contrast, this embodiment of the inventive device has no on-board memory except the one used for caching, and no actual device implementation code/firmware. The inventive device delivers translated host requests to the remote server for execution transparently, without even knowing what device it is emulating—hard disc, memory card, tape, optical disc, etc.

Further to this difference, prior art boards emulate a “memory device” only, while the invention is not limited to that. Indeed, the inventive device can represent any storage device, including but not limited to Hard Disk, CDROM, Tape, Scanner, etc. The type of device emulated is determined by the server configuration—that is, the inventive board just connects to the server and virtually attaches it to the local host as if is connected to the host directly. Said another way, the prior art emulates memory devices only, and thus these prior art devices are built around the memory allocation logic. But the inventive device has no such logic. Instead, the logic for the device is contained on the server and, as discussed above, the emulation may be not just memory-oriented, but something more advanced.

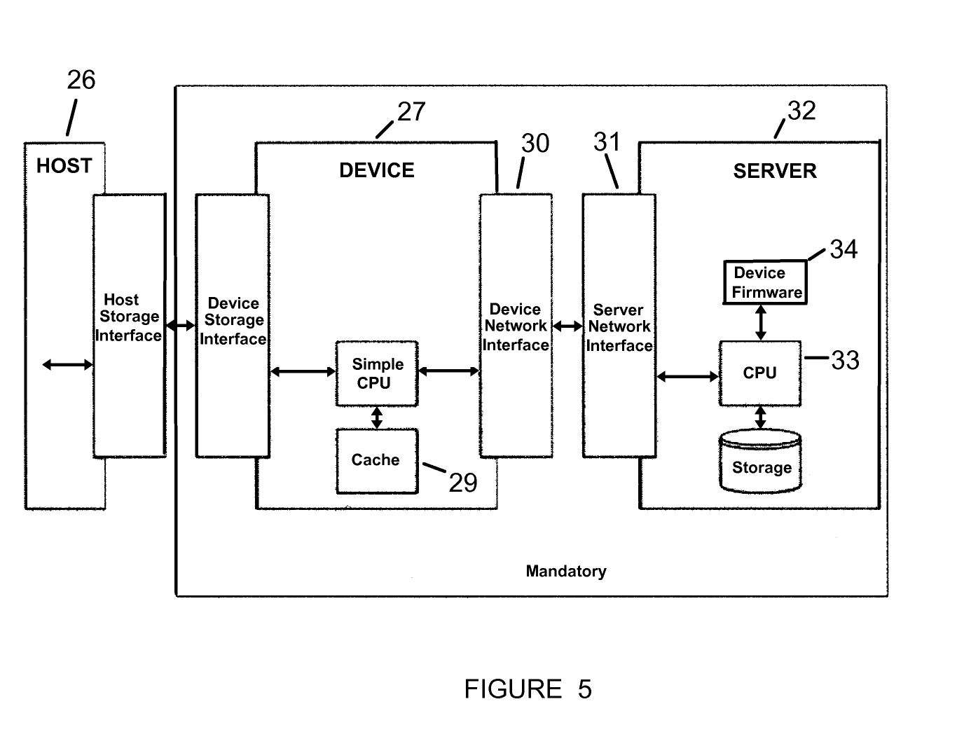

As shown in FIG. 5, in this embodiment of the inventive device, host 26 initiates I/O requests to device 27. Device 27 has a simple CPU 28, which contains no firmware. Simple CPU 28 can also be thought of as a “reduced” CPU—but not in the context of a Reduced Instruction Set Computer (RISC) which it is not. Instead, it is a very simple processor that runs translation (wrapping) of bus traffic to protocol-specific commands, but does not do the typical firmware processor job.

Simple CPU 28 fetches data from cache 29 if data satisfying the I/O request is in the cache. If data satisfying the I/O request is not in the cache, simple CPU 28 uses device network interface 30, communicating with server network interface 31, to talk to server 32. Server 32 has a CPU 33 which contains the device firmware 34 for device 27. If there is no connection established between device 27 and server 32, then device 27 cannot work because there is no data on device 27 and because device 27 has no actual implementation code/firmware and needs all requests to be processed by server 32.

Notwithstanding device 27's lack of firmware and lack of on-board memory except for the cache, with this embodiment the data communications and exchanges are still the same as the data communications and exchanges shown on FIG. 1. For example, device 27 receives storage interface commands (for example, SATA) and translates them to network protocol specific ones (for example iSCSI). Device 27 in essence acts as a bi-directional wrapper. If the command is a medium-access command and the decoded address is in cache 29, device 27 executes the command without actual data I/O over the network (status codes are still updated on server 32). Server 32 receives the iSCSI commands and executes them. Server 32 can be a third-party module. Thus, all traffic is being routed to server 32 for execution, and the traffic is bi-directional.

In other words, the presence of both device 27 and server 32 is mandatory for this inventive embodiment to function. Since the device firmware runs on the server, the inventive device can exchange data on both sides, and thus can act as a multi-path disk device (for example, an SAS).

In contrast, in prior art systems, even if data is stored on the server (that is, local memory is used as a cache), the device can only serve I/O requests for the purposes of the physically attached host. So prior art devices are not true multi-path disk devices. Since prior art systems run the device implementation code/firmware on the device and not on the server, they would need multiple physical connections to achieve fully transparent functionality.

Further to this aspect, if the server notices data or metadata (lock tables) modifications from another connected device, it has a method to trigger back attention from the current connected device so it would signal to the host that its attached-to-device state has been changed. One example of this is dual-port SAS hard disk emulation. The inventive system can do this properly, since the server acts as the device firmware and both the “devices” act as active data ports)—but other systems cannot.

In sum, while prior art devices can function without access to a server (for example, reporting less available storage space to the user), for the inventive embodiment having an established connection to a server is an essential part of the system. Said another way, in prior art systems, the server component is an improvement and an extension of basic functionality—while in this inventive embodiment, the server is a necessary part of the system.

### CONCLUSIONS, RAMIFICATIONS, AND SCOPE

Thus the reader will see that the network storage device of the invention is a “fully hardware” network storage solution that needs no additional operating system support except the support already built-in for the existing storage controller.

While the above descriptions contain many specificities, these shall not be construed as limitations on the scope of the invention, but rather as exemplifications of embodiments thereof. Many other variations are possible without departing from the spirit of the invention. Examples of just a few of the possible variations follow:

Although the description mentions a PCI IDE controller as the default storage controller used to communicate with our intellectual network storage device via PATA (parallel ATA) interface, the invention is not confined to using this interface alone. As just a few examples, the iNSD of the invention can be connected to a PCI IDE controller also via a SATA (Serial ATA) interface.

Even a completely different interface may be used, for example USB, if the iNSD is attached to an enhanced host controller implementing a USB 2.0 interface on the motherboard. In this case, the iNSD of the invention can be plugged directly into any available hub attached to the enhanced host controller—internal or external, depending on the motherboard implementation. The invention's use with still other interfaces is envisioned, including those not yet developed.

The description and figures primarily discuss a PCI IDE controller as the existing storage controller of the host computer. However, the iNSD of the invention may be connected to another type of existing storage controller, including but not limited to an enhanced host controller as discussed above.

In sum, whatever type of existing storage controller the iNSD is connected to, or whatever type of interface is used to connect the iNSD to the storage controller, what is important is that the iNSD is considered by the OS of the host computer to be a storage device co-working with the existing storage controller—and therefore, the iNSD does not require any additional software to operate.

Although the figures show the device board communicating with just one remote storage server, in actuality there may be more than one remote storage server. That is, the device board can communicate with multiple remote storage servers simultaneously.

The description and figures show the device board communications with the storage controller, and the device board communications with the remote storage server, to be of a known or standard type—for example, standard ATA/ATAPI protocol or standard USB, and standard network packets respectively. However, while the use of standard communication protocols has its advantages, the invention is not confined to them. Non-standard communications means may also be used.

The connection between the iNSD and the existing storage controller can be a physical wired connection, or alternatively it may be a wireless connection.

Accordingly, the scope of the invention should be determined not by the embodiments illustrated, but by the appended claims and their legal equivalents.

What is claimed is:

1. A storage system, comprising:
(a) a device board that emulates a storage interface dependent device, said device board comprising a cache but no other on-board memory, and a simple central processing unit without firmware, and said emulation including said device board receiving at least one storage interface command sent from a storage controller of a computer and, depending on whether data responsive to said at least one storage interface command is located in said memory, said device board either analyzing and responding to said at least one storage interface command by itself, or wrapping said at least one storage interface command into a network interface dependent protocol;
(b) means for connecting said device board to said storage controller, in order that said computer recognizes said device board as co-working with said storage controller; and
(c) a remote storage server communicating with said device board and containing firmware for the device board, said communication between said remote storage server and said device board being bi-directional and occurring over a network using network packets;
whereby said storage device does not require an associated device driver on said computer to operate.

2. The device of claim 1, wherein said storage controller is a Peripheral Component Interconnect Integrated Drive Electronics controller.

3. The device of claim 1, wherein said storage controller is an enhanced host controller.

4. The device of claim 1, wherein said means for connecting comprises an Advanced Technology Attachment interface.

5. The device of claim 1, wherein said means for connecting comprises a Universal Serial Bus interface.

6. The device of claim 1, wherein said communication between said device board and said remote storage server is via a wired connection.

7. The device of claim 1, wherein said communication between said device board and said remote storage server is via a wireless connection.

8. A remote storage system, comprising:
(a) a device board that emulates a storage interface dependent device, said device board comprising a cache but no other on-board memory, and a simple central processing unit without firmware;
(b) a computer having a storage controller;
(c) said emulation including said device board receiving at least one storage interface command sent from said storage controller and, depending on whether data responsive to said at least one storage interface command is located in said memory, said device board either analyzing and responding to said at least one storage interface command by itself, or wrapping said at least one storage interface command into a network interface dependent protocol;
(d) a remote storage server containing firmware for the device board;
(e) a first communications connection between said device board and said storage controller, in order that said computer recognizes said device board as co-working with said storage controller; and
(f) a second communications connection between said device board and said remote storage server, said second communications connection being bi-directional and occurring over a network using network packets.

9. The system of claim 8, wherein said storage controller is a Peripheral Component Interconnect Integrated Drive Electronics controller.

10. The system of claim 8, wherein said storage controller is an enhanced host controller.

11. The system of claim 8, wherein said first communications connection comprises an Advanced Technology Attachment interface.

12. The system of claim 8, wherein said first communications connection comprises a Universal Serial Bus interface.

13. The system of claim 8, wherein said second communications connection is a wired connection.

14. The system of claim 8, wherein said second communications connection is a wireless connection.

15. A method of communicating between a computer and a remote storage server, comprising the steps of:
(a) providing a device board that emulates a storage interface dependent device, said device board comprising a cache but no other on-board memory, and a simple central processing unit without firmware, and said emulation including said device board receiving at least one storage interface command sent from a storage controller of a computer and, depending on whether data responsive to said at least one storage interface command is located in said memory, said device board either analyzing and responding to said at least one storage interface command by itself, or wrapping said at least one storage interface command into a network interface dependent protocol;
(b) providing means for connecting said device board to a storage controller of the computer, in order that said computer recognizes said device board as co-working with said storage controller; and
(c) communicating between said device board and the remote storage server bi-directionally and over a network using network packets, the remote storage server containing firmware for the device board.

16. The method of claim 15, wherein said storage controller is a Peripheral Component Interconnect Integrated Drive Electronics controller.

17. The method of claim 15, wherein said storage controller is an enhanced host controller.

18. The method of claim 15, wherein said means for connecting comprises an Advanced Technology Attachment interface.

19. The method of claim 15, wherein said means for connecting comprises a Universal Serial Bus interface.

20. The method of claim 15, wherein said means for communicating comprises a wired connection.
